(19) United States
(12) Patent Application Publication
(10) Pub. No.: US 2007/0256470 A1
(43) Pub. Date: Nov. 8, 2007

(54) Device for Calibrating an Extruded Plastic Profile

(76) Inventors: Dietmar Gruber, Schlierbach (AT); Wolfgang Gasselseder, Oberneukirchen (AT); Erwin Krumbock, Ansfelden (AT)

Correspondence Address: WILLIAM COLLARD;COLLARD & ROE, P.C., 1077 NORTHERN BOULEVARD, ROSLYN, NY, 11576, US

(21) Appl. No.: 11/659,391

(22) PCT Filed: Jun. 29, 2005
(86) PCT No.: PCT/AT05/00242

§ 371 Date: Mar. 8, 2007

(30) Foreign Application Priority Data
Aug. 6, 2004 (AT) 1350/2004

(51) Int. Cl. G01L 27/00

(52) U.S. Cl. 73/1.58

(57) ABSTRACT

A device is described for calibrating an extruded plastic profile having a support stand (2), which is assembled from hollow profiles, for a cooling and calibration unit (1) and having supply lines, which are provided in the stand (2), for the cooling and calibration unit (1). In order to provide simple construction conditions, it is suggested that at least individual hollow profiles (6, 7) of the stand (2) be implemented as supply lines having connections (9, 18) for the cooling and calibration unit.

### 1. FIELD OF THE INVENTION

The present invention relates to a device for calibrating an extruded plastic profile having a support stand, assembled from hollow profiles, for a cooling and calibration unit, and having supply lines provided in the stand for the cooling and calibration unit.

### 2. DESCRIPTION OF THE PRIOR ART

Plastic profiles exiting from a shaping extrusion die are conveyed through a cooling and calibration unit, which is supplied with coolant and, in addition, is impinged with a partial vacuum, in particular with hollow chamber profiles, to suction the profile walls in the area of the hollow chamber against the calibration surfaces of the calibration tool with the aid of vacuum slots oriented transversely to the strand passage direction. Supplying the cooling and calibration unit with coolant liquid and, in addition, with an appropriate partial vacuum requires multiple supply lines, to which the cooling and calibration unit is to be connected with the aid of connection lines. The supply lines are laid in a support stand which accommodates the cooling and calibration unit, which is not only connected to a comparatively high installation effort, but rather also causes space difficulties.

### SUMMARY OF THE INVENTION

The present invention is thus based on the object of implementing a device for calibrating an extruded plastic profile of the type described at the beginning in such a way that the cooling and calibration unit may advantageously be supplied with coolant liquid and impinged by partial vacuum with less space required and a lower installation effort.

The present invention achieves the stated object in that at least individual hollow profiles of the stand are implemented as a supply line having connections for the cooling and calibration unit.

Since the support stands for the interchangeably used cooling and calibration units are typically assembled from hollow profiles for weight reasons, these hollow profiles may advantageously be used as supply lines if they are provided with appropriate connections for the cooling and calibration unit. Therefore, the installation effort for the supply lines which is otherwise necessary is dispensed with. In addition, because of the lack of separate supply lines, a simple construction results, which provides advantageous space conditions for accommodating the particular cooling and calibration unit and for connecting this cooling and calibration unit to the supply lines formed by the hollow profiles of the stand.

If the support stand for accommodating a cooling and calibration unit has two lateral longitudinal frames, the upper and lower longitudinal legs of the longitudinal frames may form the supply lines in the form of distribution and collection channels for a coolant liquid. Especially simple attachment connections having short connection lines may be implemented using such distribution and collection channels.

At least one longitudinal leg of the longitudinal frames may have two parallel hollow chambers for impinging the cooling and calibration unit with a partial vacuum, one of which is provided for the coolant while the other is impinged with partial vacuum. The hollow chamber impinged with partial vacuum may be subdivided into at least two vacuum sections, in order to obtain multiple vacuum loops for the cooling and calibration unit which are independent of one another.

The hollow profiles of the stand may fulfill tasks which go beyond the function of mere supply lines. Thus, for example, it is possible in a stand having transverse frames which connect stand lateral parts to one another to implement the hollow profiles of at least one these transverse frames as a condenser chamber for coolant liquid connected to the pressure side of a vacuum pump, through which separate condenser chambers which are otherwise necessary may be dispensed with.

Since deposits are always to be expected in supply lines, these supply lines are to be maintained, for example, with the aid of cleaning lances, via which a medium may be introduced under pressure into the supply lines. To make such maintenance work easier, the hollow profiles of the stand implemented as supply lines may have closable cleaning openings.

### BRIEF DESCRIPTION OF THE DRAWING

The subject matter of the present invention is illustrated as an example in the drawing.

FIG. 1 shows the stand of a device according to the present invention for calibrating an extruded plastic profile in a simplified diagram,

FIG. 2 shows the stand from FIG. 1 in a side view, and

FIG. 3 shows a section along line III-III of FIG. 2.

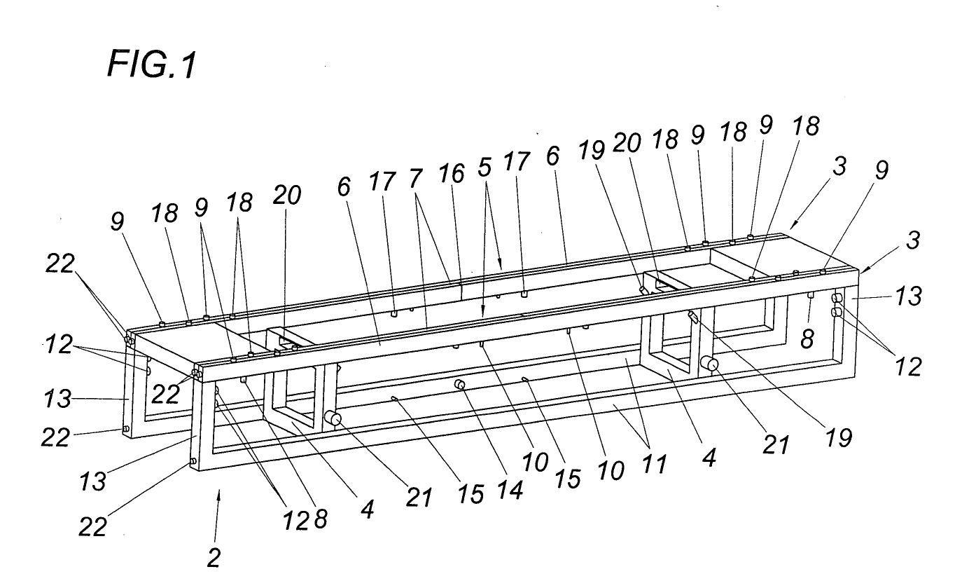

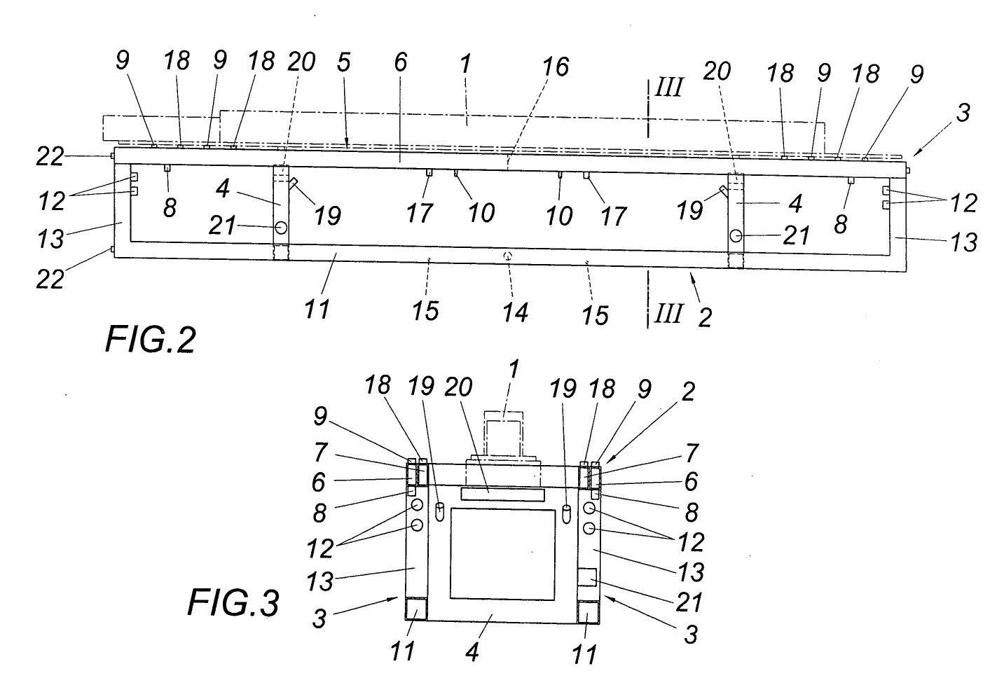

### DESCRIPTION OF THE PREFERRED EMBODIMENT

According to the exemplary embodiment illustrated, the stand 2, which is only indicated by dot-dash lines, supporting the cooling and calibration unit 1 of a device (not shown in greater detail for reasons of clarity) for calibrating an extruded plastic profile has two lateral longitudinal frames 3, which are connected to one another by transverse frames 4. The upper longitudinal legs 5 of the longitudinal frame 3 are each formed by two hollow profiles 6, 7, running parallel next to one another, of which the particular external hollow profiles 6 are supplied with coolant liquid via connections 8. These hollow profiles 6 are provided with prepared connections 9 for the cooling and calibration tool 1 and with connections 10 for the supply of secondary assemblies, such as a vacuum pump. The return flow of the coolant liquid occurs via the hollow profile of the lower longitudinal legs 11 of the longitudinal frames 3, the connection to the cooling and calibration unit 1 being able to be produced via connections 12 in the vertical frame legs 13. The connection for the water pump is identified by 14. The secondary assemblies may be connected via connections 15 on the lower longitudinal legs 11. The hollow profiles 6 of the upper longitudinal legs 5 thus result in a distribution channel and the lower longitudinal legs 11 result in a collection channel for the coolant water conduction via the cooling and calibration unit 1 and the associated secondary assemblies.

The particular inner hollow profiles 7 of the upper longitudinal legs 5 of the longitudinal frames 3 are used for impinging the cooling and calibration unit 1 with a partial vacuum. These hollow profiles 7 are subdivided in their longitudinal middle by partition walls 16, so that a total of four vacuum sections result for four vacuum loops which are separate from one another. Connections 17 are used for connecting hollow profiles 7 to a vacuum pump. Connections 18 are provided for impinging the cooling and calibration unit 1.

The volume of the hollow profiles forming the transverse frames 4 may advantageously also be used, for example, as a condenser chamber for coolant liquid on the pressure side of a vacuum pump. For this purpose, the transverse frames 4 are connected via connections 19 to the pressure side of the vacuum pump. The condensed coolant liquid collects in the hollow transverse frames 4, while the air may escape via aeration openings 20 from the condenser chamber formed by the transverse frames. Since the transverse frames 4 have flow connections to the lower longitudinal legs 11 of the longitudinal frames 3, the condensed coolant liquid is incorporated into the coolant liquid loop. The coolant liquid is discharged from the transverse frames 4 via separate drain lines 21.

In order to be able to clean the supply lines formed by the hollow profiles 6 and 7 of the upper longitudinal legs 5 and the supply lines in the area of the lower longitudinal legs 11 if needed, the supply lines are provided on their front faces with closable cleaning openings 22, through which cleaning lances may be inserted into the supply lines.

Of course, the present invention is not restricted to the exemplary embodiment illustrated. Thus, for example, the hollow profiles 6 and 7 may be replaced by a shared hollow profile having two hollow chambers. In addition, the stand construction made of longitudinal and transverse frames is not required, since it is only important that the stand 2 have corresponding hollow profiles which may be used as supply lines.

1. A device for calibrating an extruded plastic profile having a support stand, which is assembled from hollow profiles, for a cooling and calibration unit and having supply lines, which are provided in the stand, for the cooling and calibration unit, wherein at least individual hollow profiles (6, 7) of the stand (2) are implemented as supply lines having connections (9, 18) for the cooling and calibration unit.

2. The device according to claim 1 having a stand made of two lateral longitudinal frames, wherein the supply lines of the upper and lower longitudinal legs (5, 11) of the longitudinal frames (3) are implemented as distribution and collection channels for a coolant liquid.

3. The device according to claim 2, wherein at least one longitudinal leg (5) of the longitudinal frames (3) has two hollow chambers (hollow profiles 6, 7), one of which conducts coolant liquid and the other of which is impinged with a partial vacuum.

4. The device according to claim 3, wherein the hollow chamber (hollow profile 7) which may be impinged with partial vacuum is subdivided into at least two vacuum sections.

5. The device according to claim 1 having a stand which has transverse frames connecting stand lateral parts to one another, wherein the hollow profiles of at least one transverse frame (4) are implemented as a condenser chamber, which is connected to the pressure side of a vacuum pump, for coolant liquid.

6. The device according to claim 1, wherein the hollow profiles (6, 7) implemented as supply lines have closable cleaning openings (22).
